(19) United States
(12) Patent Application Publication
(10) Pub. No.: US 2008/0067146 A1
(43) Pub. Date: Mar. 20, 2008

(54) Plasma processing apparatus, method for detecting abnormality of plasma processing apparatus and plasma processing method

(76) Inventors: Katsuhiko Onishi, Toyama (JP); Hiroki Imamura, Niigata (JP)

Correspondence Address: MCDERMOTT WILL & EMERY LLP, 600 13TH STREET, NW, WASHINGTON, DC, 20005-3096, US

(21) Appl. No.: 11/898,144

(22) Filed: Sep. 10, 2007

(30) Foreign Application Priority Data
Sep. 15, 2006 (JP) 2006-250990

(51) Int. Cl. B05D 1/00; B05C 5/00; G01N 7/00

(52) U.S. Cl. 216/59; 156/345.26; 216/67; 73/31.04

(57) ABSTRACT

The plasma processing apparatus relating to the present invention is provided with a process chamber, a pressure measuring unit for measuring the pressure inside of the process chamber and a pump for exhausting a gas in the process chamber. A pressure control valve for maintaining the pressure inside of the process chamber to a predetermined pressure by regulating an opening based on a measured value of the pressure measuring unit is provided between the pump and the process chamber. An exhaust capacity controller sets up the exhaust capacity in a state that the variation of the opening of the pressure control valve in response to the pressure fluctuation inside of the process chamber is large. A computing unit detects very small pressure fluctuation based on the variation of the opening of the pressure control valve. In results, enabling reliable detection of a very small gas flow fluctuation and pressure fluctuation by a less expensive method independent of process conditions.

### CROSS-REFERENCE TO RELATED APPLICATION

The present application claims the benefit of patent application number 2006-250990, filed in Japan on Sep. 15, 2006, the subject matter of which is incorporated herein by reference.

### BACKGROUND OF THE INVENTION

1. Field of the Invention

The present invention relates to a plasma processing apparatus for performing plasma processing of an object arranged in a process chamber, a method for detecting abnormality of the apparatus and a plasma processing method.

2. Description of the Related Art

Recently, the specification of processing conditions has tended to become technologically stricter, with high-integration, high functionalization and acceleration of operating speed of semiconductor integrated circuit devices (hereafter referred to as semiconductor devices). The manufacturing cost of semiconductor devices also has tended to rise in terms of management and reducing processing deficiencies has been desired in terms of cost. For small-quantity production of various models, reducing processing deficiencies has also been desired in terms of delivery. Therefore, various techniques for monitoring specific parameters of processing apparatus for manufacturing semiconductor devices and detecting abnormalities of processing apparatus at an early stage have been proposed.

FIG. 9 is a diagram showing a two-frequency type plasma processing apparatus as an example of a plasma processing apparatus frequently used in the manufacturing process of semiconductor devices. As shown in FIG. 9, the plasma processing apparatus has a structure in which a process chamber 101 for performing plasma processing and a wafer transport chamber 201 are communicated by a wafer transport path 303. A gate valve 302 for isolating a plasma atmosphere from the plasma chamber 101 is provided in the wafer transport path 303 with openable/closeable. The gate valve 302 is placed on the wafer transport chamber 201 side, and a gate valve O-ring 301 is arranged at a face where the inner surface of the gate valve 302 and the inner surface of the wafer transport chamber 201 come into contact. The wafer transport chamber 201 has a conveyance mechanism (non-illustrated) for moving a wafer 102 into and out of the process chamber 101 via the gate valve 302.

In the process chamber 101, a wafer stage 103 arranged with the wafer 102 is placed. An upper electrode 110 is buried in a top plate opposite to the wafer stage 103. A lower power source 105 is connected to the wafer stage 103, and an upper power source 104 is connected to the upper electrode 110. A gas supply system 109, such as a gas supply source 108, is connected into the upper electrode 110 in a communicated state. A gas supplied in a flow-controlled state by the gas supply system 109 is jetted from multiple holes formed in a gas jet plate 111 constructing the downside of upper electrode 110 to the wafer stage 103. In this state, plasma of gas introduced into the process chamber 101 is generated by applying a high-frequency electric power on the upper electrode 110 and the wafer stage 103 with the upper power source 104 and the lower power source 105.

An exhaust section 107 communicating the process chamber 101 and an exhaust region 112 is provided in the lower part of side wall of the process chamber 101 opposite to the wafer transport path 303. An exhaust port 113 is equipped at the bottom of exhaust region 112, and an exhaust gate valve 106 for opening/closing the exhaust port 113 is provided. An exhaust pipe 410 connected with equipments relating to exhaust, such as a pressure control valve 402, a turbo molecular pump (TMP) 403 and a dry pump 404, etc., is connected to the exhaust port 113. Gas in the process chamber 101 is arranged so as to flow through the exhaust section 107, exhaust region 112, exhaust port 113 and then exhausted to the outside of the process chamber 101.

A pressure measuring unit 401 for measuring the pressure inside the process chamber 101 is connected to the process chamber 101. The measurement result of the pressure measuring unit 401 is input to a pressure controller 501 as an electric signal. The pressure controller 501 maintains the pressure inside of the process chamber 101 to a predetermined pressure by regulating the opening of the pressure control valve 402 based on an output signal of the pressure measuring unit 402.

In the plasma processing apparatus, multiple parameters such as supply gas flow rate, exhaust gas flow rate, substrate temperature, etc. is controlled, and processing deficiencies occur due to abnormal fluctuation of these parameters. It is important to detect fluctuation of these parameters at an early stage. For example, etching shape deficiency caused by fluctuation of etching gas such as fluorocarbon gas, etc., etching shape deficiency caused by resist burning due to leakage of He gas being a heating medium of rear side of wafer, etching shape deficiency caused by resist burning due to abnormal discharge of plasma, etc. are given as processing deficiencies in dry etching process of oxide film. It is important to detect these abnormalities at an early stage to reduce such processing deficiencies. When these abnormalities occur, an operator certainly notices them if equipment stoppage occurs. However, when abnormal discharge, etc. randomly occur and equipment stoppage does not occur, many processing deficiencies likely occur.

Various techniques have been proposed for detecting abnormalities as described above. For example, a technique for monitoring the opening of a pressure control valve is been proposed in Japanese Laid-Open Patent Application H11-193464. The technique detects a reduction of exhaust capacity caused by deposition of reaction products generated in plasma processing on the exhaust side with the manufacture of semiconductor devices according to the opening of a pressure control valve, preventing a plasma processing apparatus from equipment stoppage due to the reduction of exhaust capacity. A technique for providing a flowmeter on a supply line with He gas serving as the heating medium of a rear side of wafer is been proposed in Japanese Laid-Open Patent Application 2000-21869. The technique detects leakage of He gas by comparing a measured value of He gas flow rate and a threshold value corresponding to the flow rate in the leakage of the He gas.

### SUMMARY OF THE INVENTION

However, in the method for detecting abnormality of a plasma processing apparatus disclosed in the above Japanese Laid-Open Patent Application H11-193464, a significant change such as the deposition of reaction products on the exhaust side can be detected, but a very small gas flow fluctuation or pressure fluctuation cannot be detected. This is because the opening of pressure control valve being a measured target usually fluctuates by about 0.1˜1.0°, although this value depends upon process conditions, exhaust capacity of the plasma processing apparatus, performance of the pressure control valve and individual differences, etc., in the plasma processing. For example, when very small fluctuations occur due to abnormal discharge and the opening of pressure control valve fluctuates, whether the fluctuation is a normal fluctuation or a fluctuation due to abnormalities cannot differentiate.

In the technique for providing detectors, such as flowmeter, for detecting abnormality, many detectors must be provided in accordance with abnormalities to be detected, therefore a practically difficult case is assumed from the standpoint of the layout and cost of the apparatus.

In view of the above, it is an objective of the present invention to provide a plasma processing apparatus that can reliably detect very small gas flow fluctuation and pressure fluctuation by less expensive methods, independently of process conditions, a method for detecting its abnormalities and a plasma processing method.

The following technical means is adopted in the present invention to achieve the above purpose. Specifically, a plasma processing apparatus relating to the present invention comprises a process chamber for performing plasma processing to an object, a pressure measuring unit for measuring a pressure inside of the process chamber, and a pump for exhausting a gas in the process chamber. A pressure control valve for maintaining the pressure inside of the process chamber to a predetermined pressure by regulating an opening of the valve based on a measured value of the pressure measuring unit is provided between the pump and the process chamber. The plasma processing apparatus also comprises a unit for varying an exhaust capacity on the exhaust side than the pressure control valve and a unit for detecting the opening of the pressure control valve.

According to this construction, the variation of the opening of the pressure control valve in response to the pressure fluctuation inside of the process chamber can be changed by regulating the exhaust capacity. In other words, it is possible to detect very small pressure fluctuation as a variation of the opening of the pressure control valve by setting the opening of the pressure control valve to a state in which the variation of the opening of the pressure control valve in response to the pressure fluctuation inside of the process chamber is large.

In the above construction, the exhaust capacity is set to a state in which the opening of the pressure control valve at the time of maintaining the pressure inside of the process chamber to the predetermined pressure becomes a predetermined opening. The predetermined opening can be set up in accordance with a pressure fluctuation inside of the process chamber to be detected.

The unit for varying the exhaust capacity can be constructed, for example, by the above pump with variable exhaust capacity. The unit for varying the exhaust capacity may comprise an exhaust capacity control valve with variable opening provided between the pressure control valve and the pump. Also, the unit for varying the exhaust capacity may comprise a gas supply unit with variable flow rate supplying a flow-controlled gas between the pressure control valve and the pump. In this case, the gas supplied between the pressure control valve and the pump is preferably an inert gas.

In the above construction, when the opening of the pressure control valve becomes a predetermined value or above, a construction for increasing the exhaust capacity on the exhaust side than the pressure control valve can also be adopted. When the opening of the pressure control valve becomes a predetermined value or above, a construction for stopping the execution of plasma process on an object to be processed next may also be adopted.

In another perspective, the present invention can provide a method for abnormality of a plasma processing apparatus which is provided a pressure control valve between a process chamber arranged with an object and a pump for exhausting a gas in the process chamber and maintains a pressure inside of the process chamber to a predetermined pressure by regulating an opening of the pressure control valve. In the method of abnormality of a plasma processing apparatus relating to the present invention, first, the opening of the pressure control valve in a state of maintaining the pressure inside of the process chamber to a predetermined pressure is set to an opening corresponding to a pressure fluctuation inside of the process chamber to be detected by varying the exhaust capacity on the exhaust side than the pressure control valve. The inside of the process chamber is maintained to the predetermined pressure in a state of the set opening of the pressure control valve, and plasma processing is performed. Then, the pressure fluctuation inside of the process chamber is detected on the basis of the variation of the opening of the pressure control valve.

This enables reliably detecting abnormality of a plasma processing apparatus associated with very small pressure fluctuation inside of the process chamber. When the pressure fluctuation inside of the process chamber is detected, for example, the following processing is performed. First, a presence or absence of abnormality of a pressure measuring unit for measuring the pressure inside the process chamber is determined. In case that abnormality in the pressure measuring unit are absent, a presence or absence of abnormality of the opening of the pressure control valve in a state that the pressure inside of the process chamber is maintained to the predetermined pressure without introducing a gas into the process chamber is determined. Then, in case that abnormality in the opening of the pressure control valve without the introduced gas are absent, it is determined that a presence or absence of abnormality of the opening of the pressure control valve in a state that a gas is introduced into the process chamber and the pressure inside of process chamber is maintained to the predetermined pressure. Thereby, it becomes possible to specify the reasons for the occurrence of abnormality.

In still another perspective, the present invention enables providing a plasma processing method applied to a plasma processing apparatus which comprises a pressure control valve between a process chamber arranged with an object and a pump exhausting a gas in the process chamber and maintains a pressure inside of the process chamber to a predetermined pressure by regulating an opening of the pressure control valve. In the plasma processing method relating to the present invention, first, the opening of the pressure control valve in a state of maintaining the pressure inside of the process chamber to a predetermined pressure is set to a predetermined opening by varying an exhaust capacity on the exhaust side than the pressure control valve. And, the pressure inside of the process chamber is maintained to the predetermined pressure in a state of the set opening of the pressure control valve and a plasma processing is performed. In this construction, the predetermined opening may be set up in accordance with the pressure fluctuation inside of the process chamber to be detected.

For example, the regulation of exhaust capacity on the exhaust side than the pressure control valve may be carried out by regulating the exhaust capacity of the pump. The regulation of exhaust capacity can be carried out by regulating the opening of an exhaust capacity control valve provided between the pressure control valve and the pump or by regulating a flow rate of a gas supplied between the pressure control valve and the pump. In this case, the gas supplied between the pressure control valve and the pump is preferably an inert gas. Moreover, when the opening of the pressure control valve becomes a predetermined value or above, a construction for increasing the exhaust capacity on the exhaust side than the pressure control valve can also be adopted.

The present invention enables reliably detecting a very small fluctuation of about 0.1 Pa in the process chamber that could not be detected before. A fluctuation of about 1 sccm in supply amount of a process gas introduced into the process chamber can also be detected as a very small pressure fluctuation in the process chamber. Namely, processing deficiencies caused by a zero point shift of the pressure measurement unit for measuring the pressure in the process chamber, processing deficiencies caused by abnormal discharge, processing deficiency caused by fluctuation of the supplied amount of a process gas, processing deficiency caused by leakage of He gas as the heating medium of rear side of wafer, etc. can be reliably detected during the initial period of abnormality occurrence. As a result, the present invention enables reliably detecting abnormality occurrence and preventing the occurrence of continuous and considerable processing deficiencies.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view showing the schematic construction of a plasma processing apparatus of the first embodiment relating to the present invention.

FIG. 2 is a graph showing a relationship between the opening of the pressure control valve and the pressure fluctuation.

FIG. 3 is a flow chart showing operations in embodiments relating to the present invention.

FIG. 4 is a flow chart showing an abnormality confirmation processing of the pressure measuring unit in embodiments relating to the present invention.

FIG. 5 is a flow chart showing an abnormality confirmation processing of leakage of the process chamber and abnormality of exhaust system in embodiments relating to the present invention.

FIG. 6 is a flow chart showing an abnormality confirmation processing of gas flow rate in embodiments relating to the present invention.

FIG. 7 is a sectional view showing the schematic construction of a plasma processing apparatus of the second embodiment relating to the present invention.

FIG. 8 is a sectional view showing the schematic construction of a plasma processing apparatus of the third embodiment relating to the present invention.

FIG. 9 is a sectional view showing the schematic construction of a prior plasma processing apparatus.

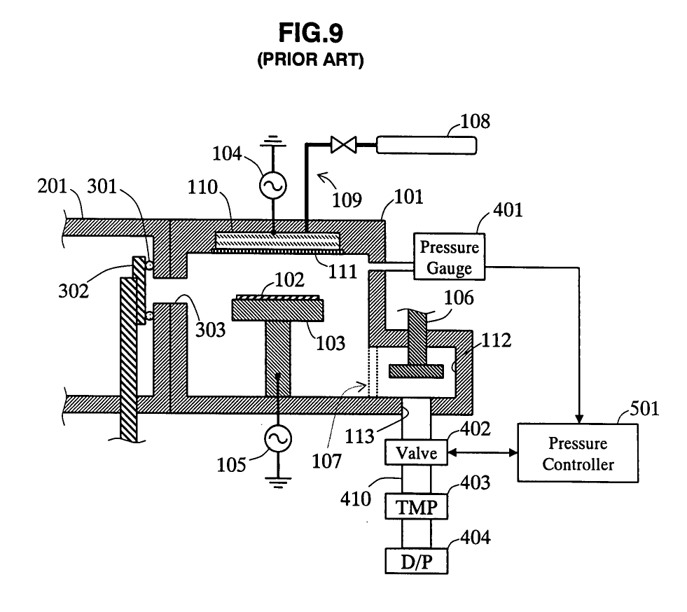

### DETAILED DESCRIPTION OF PREFERRED EMBODIMENTS

Embodiments of the present invention are described hereafter, with reference to the drawings. In embodiments below, the present invention is realized as a two-frequency parallel-plate type plasma etching apparatus.

### First Embodiment

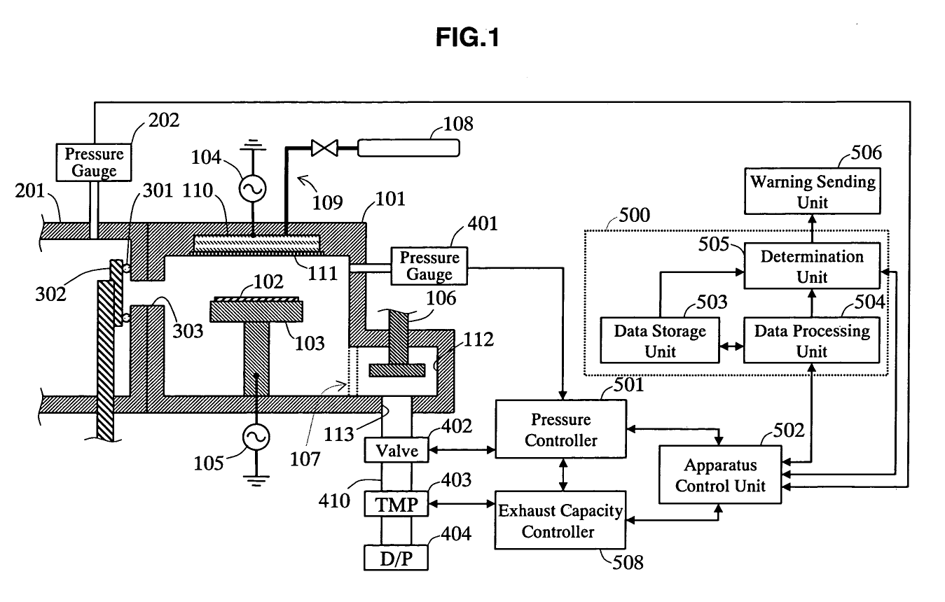

The first embodiment relating to the present invention is described hereafter with reference to the drawings. FIG. 1 is a sectional view of a plasma processing apparatus in the first embodiment of the present invention.

As shown in FIG. 1, the plasma processing apparatus of this embodiment comprises a process chamber 101 for performing a plasma processing and a wafer transport chamber 201 communicated by a wafer transport path 303. A gate valve 302 for isolating a plasma atmosphere from the process chamber 101 is provided in the wafer transport path 303 with openable/closeable.

The wafer transport chamber 201 has a conveyance mechanism (non-illustrated) for conveying a wafer 102 into and out of the process chamber 101. The gate valve 302 is placed on the wafer transport chamber 201 side, and a gate valve O-ring 301 is fixed to a surface in touch with the inner surface of the wafer transport chamber 201. A pressure measuring unit 202 for measuring the pressure in the wafer transport chamber 201 is connected to the wafer transport chamber 201. The pressure measuring unit 202 inputs a pressure measurement result to an apparatus control unit 502 described later as an electric signal.

The process chamber 101 has a wafer stage 103 arranged on the wafer 102 therein. An upper electrode 110 is buried in a top plate opposite to the wafer stage 103. A lower power source 105 is connected to the wafer stage 103, and an upper power source 104 is connected to the upper electrode 110. A gas supply system 109, such as a gas supply source 108, etc., is connected into the upper electrode 110 in a communicated state. A gas supplied in a flow-controlled state by the gas supply system 109 is jetted from multiple holes fabricated on a gas jet plate 111 constructing the downside of upper electrode 110 to the wafer stage 103. In this state, plasma of gas introduced into the process chamber 101 is generated by applying a high-frequency electric power on the upper electrode 110 and the wafer stage 103 with the upper power source 104 and the lower power source 105. Although the two-frequency parallel-plate type plasma processing apparatus is exemplified in this embodiment, the present invention can be constituted independently of a plasma source, such as a microwave plasma processing apparatus, an ICP plasma processing apparatus, a parallel-plate type plasma processing apparatus, etc.

An exhaust section 107 communicating with the process chamber 101 and an exhaust region 112 is provided on the lower part of side wall of the process chamber 101 opposite to the wafer transport path 303. An exhaust port 113 is equipped at the bottom of exhaust region 112, and an exhaust gate valve 106 for opening/closing the exhaust port 113 is provided. An exhaust pipe 410 connected with equipments relating to exhaust, such as a pressure control valve 402, a turbo molecular pump 403 and a dry pump 404, etc., is connected to the exhaust port 113. Gas in the process chamber 101 is arranged so as to flow through the exhaust section 107, exhaust region 112, exhaust port 113 and then is exhausted to the outside of the process chamber 101.

A pressure measuring unit 401 for measuring the pressure inside the process chamber 101 is connected to the process chamber 101. The measurement result of pressure measuring unit 401 is input to a pressure controller 501 as an electric signal. The pressure controller 501 controls the opening of the pressure control valve 402 based on the output signal of the pressure measuring unit 401, maintaining the pressure inside of the process chamber 101 to a predetermined pressure. The pressure controller 501 also functions as a detector for detecting the opening of the pressure control valve 402.

In this embodiment, the pressure controller 501 outputs the opening of the pressure control valve 402 and the output value of the pressure measuring unit 401 to an exhaust capacity controller 508 and the apparatus control unit 502.

The exhaust capacity controller 508 is connected to the turbo molecular pump 403 connected to the exhaust side than the pressure control valve 402 and inputs a setup signal of revolution to the turbo molecular pump 403. Thus, the exhaust capacity controller 508 can freely regulate the exhaust capacity of the turbo molecular pump 403 by adopting a construction capable of setting the revolution of the turbo molecular pump 403. Moreover, the exhaust capacity controller 508 fetches a signal indicating the current revolution and running status of the turbo molecular pump 403 from the turbo molecular pump 403. Furthermore, the exhaust capacity controller 508 outputs the setup signal of revolution to the turbo molecular pump 403 and a signal indicating the fetched current revolution and running status of the turbo molecular pump 403 to the apparatus control unit 502.

The apparatus control unit 502 is connected to the pressure controller 501, the exhaust capacity controller 508 as well as various controllers (non-illustrated) for controlling operations of the plasma processing apparatus. The apparatus control unit 502 fetches information of operating status of each unit in the plasma processing apparatus from the controllers and gives operating instructions to the controllers. Here, the various controllers are a controller for controlling flow rates of various gases supplied to the process chamber 101 by the gas supply system 109, a controller for controlling operations, such as wafer conveying between the wafer transport chamber 301 and the process chamber 101, etc., a controller of the upper power source 104 and lower power source 105, etc., and a controller for controlling temperatures of the upper part, lower part and side wall, etc. of the process chamber 101. The apparatus control unit 502 has a display device such as a monitor, etc. and is so constructed to make display various data showing the state of the plasma processing apparatus and a warning of apparatus abnormalities. In this embodiment, the apparatus control unit 502 is connected to the pressure controller 501 such that the start of pressure control and the request of data transmission, etc. can be transmitted to the pressure controller 501. And, the pressure controller 501 and the exhaust capacity controller 508 are connected so that the information can be transmitted/received.

A computing unit 500 for making a determination of apparatus abnormalities is connected to the apparatus control unit 502. The computing unit 500 has a data processing unit 504, a data storage unit 503 and a determination unit 505. The data processing unit 504 processes various data output from the apparatus control unit 502 for determining apparatus abnormalities. The data storage unit 503 stores fetched data, specification values for determining whether there are apparatus abnormalities or not. The determination unit 505 determines whether there are apparatus abnormalities or not by comparing the data processed by the data processing unit 504 and the specification values prestored in the data storage unit 503. A warning sending unit 506 is connected to the determination unit 505. When the determination unit 505 determines that there are apparatus abnormalities, the determination unit 505 instructs the sending warning to the warning sending unit 506. The warning sending unit 506 informs apparatus abnormalities to an operator by generation of buzzer sound, light-up of warning lamp, warning display, etc.

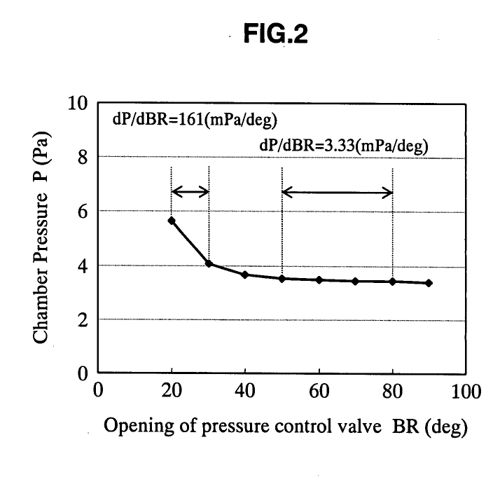

FIG. 2 is a graph showing a relationship between the opening of the pressure control valve 402 and the pressure inside of the process chamber 101 where a gas of a constant flow rate is introduced into the process chamber 101 and the opening of the pressure control valve 402 is changed. Here, the pressure control valve 402 is a so-called butterfly valve or a pendulum valve, and the opening of the pressure control valve 402 is expressed by an angle BR between 0° (closed) to 90° (fully opened).

As is understood from FIG. 2, if the opening BR of the pressure control valve 402 is small, the variation of chamber inner pressure P relative to the variation of the opening BR of the pressure control valve 402 is large. If the opening BR of the pressure control valve 402 is large, the variation of chamber inner pressure P relative to the variation of the opening BR of the pressure control valve 402 is small. For example, if the opening BR of the pressure control valve 402 is between 20° and 30°, the change rate dP/dBR of the chamber inner pressure P relative to the opening BR is about 161 mPa/deg. On the other hand, if the opening BR is between 50° and 80°, the change rate dP/dBR of the chamber inner pressure P relative to the opening BR is about 3.33 mPa/deg. Data shown in FIG. 2 are data in a state that no plasma is generated in the process chamber 101. However, the relationship between the opening BR of the pressure control valve 402 and the chamber inner pressure P shows the same tendency as FIG. 2 even in a state in which plasma is generated in the process chamber 101.

As described above, for example, when an oxide film formed on the wafer 102 is etched by dry etching, etching shape deficiency caused by fluctuation of flow rate of fluorocarbon gas, etc., etching shape deficiency caused by resist burning due to leakage of He gas being a heating medium of rear side of wafer, etching shape deficiency caused by resist burning due to abnormal discharge, etc. occur as processing deficiencies. A fluctuation of gas flow rate at a level of 1 sccm and a pressure fluctuation at a level of 0.1 Pa must be detected to find out these abnormalities at an early stage. In case of a process chamber of about 4,000 cc, for example, if the gas flow rate fluctuates by 1 sccm, a pressure fluctuation of about 0.01˜0.1 Pa occurs, although this is also dependent upon process conditions. Accordingly, the occurrence of abnormalities can be detected by detecting the pressure fluctuation of this level.

The opening of the pressure control valve 402 varies with process conditions, for example, the prior opening of the pressure control valve 402 in the normal state is 20.0°. In this case, if the chamber inner pressure P fluctuates by +0.1 Pa due to abnormal discharge, the inner pressure of the process chamber 101 is returned to the pressure before the fluctuation, therefore the pressure controller 501 changes the opening BR of the pressure control valve 402 to about 20.6° (see FIG. 2). However, the opening of the pressure control valve 402 usually fluctuates in the range of about 0.1˜1.0° in practice of pressure control although it is dependent upon performance of the pressure control valve 402 and individual differences. Therefore, whether the above fluctuation of 0.6° of the opening BR is a fluctuation due to abnormalities or a normal fluctuation cannot be determined.

Accordingly, in this embodiment, the opening of the pressure control valve 402 is set to a state that the variation of the opening of the pressure control valve 402 in response to the fluctuation of chamber inner pressure is large by varying the exhaust capacity. Namely, the plasma processing apparatus of this embodiment is set to a state that the opening of the pressure control valve 402 in the normal state becomes 50.0° under the same process conditions as prior conditions by varying the exhaust capacity of the turbo molecular pump 403 with the exhaust capacity controller 508. In this case, when the chamber pressure fluctuates by +0.1 Pa due to abnormal discharge, the pressure controller 501 changes the opening BR of the pressure control valve 402 to about 80.0° (see FIG. 2). Accordingly, this embodiment enables clearly differentiating a fluctuation of the opening BR of the pressure control valve 402 in the normal operation (0.1˜1.0°) and a fluctuation of the opening BR due to abnormalities. Namely, a state different from the normal state can be clearly determined though it cannot be specified as a reason for the fluctuation.

One example of fluctuation of the exhaust capacity is shown below. Here, when the revolution of the turbo molecular pump 403 is 30,000 rpm, the opening BR of the pressure control valve 402 for realizing a normal processed state in the process chamber 101 is 20°. In this embodiment, the revolution of the turbo molecular pump 403 is regulated so that the opening BR of the pressure control valve 402 becomes 50° in a state that the process chamber 101 is in the normal processed state. Here, when the revolution is 25,000 rpm, the opening BR of the pressure control valve 402 for realizing the above normal processed state becomes 50°. In this embodiment, this revolution (25,000 rpm) is stored in the exhaust capacity controller 508, and the exhaust capacity controller 508 sets the revolution of the turbo molecular pump 403 to 25,000 rpm according to an instruction from the apparatus control unit 502. And, in this state, plasma processing is performed.

However, as compared with a case of revolution 30,000 rpm, the pressure control in the process chamber 101 becomes unstable in the state of reducing the revolution to 25,000 rpm in this manner. This is due to the fact that the fluctuation of the chamber inner pressure P in response to the opening BR of the pressure control valve 402 is small. For example, even if the opening BR is changed from 50° to 90°, the chamber inner pressure P is only lowered by about 0.1 Pa. Also, when the chamber inner pressure P is increased by +0.3 Pa, the chamber inner pressure cannot be returned to the pressure before the fluctuation even if the pressure control valve 402 is fully opened. Therefore, there is such a possibility that the pressure inside of the process chamber 101 cannot be maintained to an intended pressure.

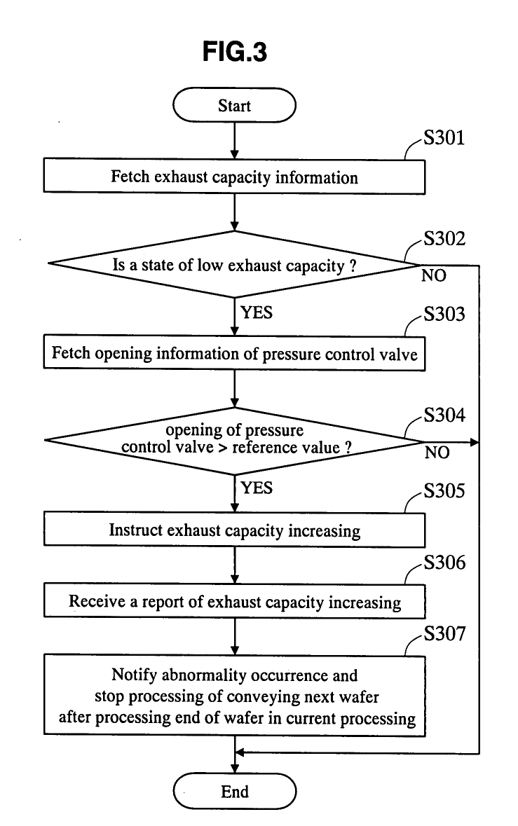

Accordingly, in the plasma processing apparatus of this embodiment, a control is carried out to avoid that the pressure inside of the process chamber 101 cannot be controlled. FIG. 3 is a flow chart showing a procedure for this control. Here, the computing unit 500 is realized by a hardware having a processor and memories such as RAM and ROM, etc. and software stored in the memories and operating on the processor.

As shown in FIG. 3, first, the apparatus control unit 502 fetches exhaust capacity information through the exhaust capacity controller 508 (step S301). In this embodiment, the exhaust capacity information is the revolution of the turbo molecular pump 403. If the exhaust capacity is low (25,000 rpm), the apparatus control unit 502 always fetches opening information of the pressure control valve 402 through the pressure controller 501 (step S302 YES, step S303). In this embodiment, the opening information is an angle of the pressure control valve 402 (the opening BR).

Next, the data processing unit 504 stores the fetched opening BR in the data storage unit 503 and transmits it to the determination unit 505. The determination unit 505 reads a prestored abnormality determination reference value from the data storage unit 503 and compares this reference value and the fetched opening BR. Then, if the fetched opening BR is greater than the reference value, the determination unit 505 determines that an abnormality is present (step S304 YES). Here, the abnormality determination reference value is set to be 80°.

When the determination unit 505 determines that an abnormality is present and notifies that to the apparatus control unit 502. At this time, the apparatus control unit 502 instructs an exhaust capacity increasing to the exhaust capacity controller 508 (step S305). The exhaust capacity controller 508 receiving the instruction increases the exhaust capacity of the turbo molecular pump 403. Here, the exhaust capacity increasing is realized by increasing the revolution of the turbo molecular pump 403 to 30,000 rpm which has been used before. If the exhaust capacity increasing of the turbo molecular pump 403 is completed, the exhaust capacity controller 508 provides notification that the exhaust capacity increasing is completed to the apparatus control unit 502 (step S306). At this time, the apparatus control unit 502 displays that the state of pressure becomes unstable in an independently provided display device. Also, the apparatus control unit 502 outputs an instruction for stopping the conveyance of the next wafer to the process chamber 101 to a wafer conveying controller after completion of the processing to the wafer being currently processed, so that the processing to the next wafer is not carried out (step S307). On the other hand, the determination unit 505 instructs a warning sending to the warning sending unit 506 at a time of determining that an abnormality is present and notifies the occurrence of an abnormality to an operator.

In the step S302, if the exhaust capacity of the turbo molecular pump 403 is not in a low state or the opening BR of the pressure control valve 402 is smaller than or equal to the reference value in the step S304, the processing ends as it is (step S302 NO, step S304 NO).

The apparatus control unit 502 can quickly detect the occurrence of an abnormality by repeatedly executing the above processing during the plasma processing.

In the above description, the reference value of the opening BR determined to be abnormal is 80°, but it is desirable that this value be changed in accordance with process conditions and state of the exhaust capacity. Also, the revolution of the turbo molecular pump 403 is changed from 25,000 rpm to 30,000 rpm at the time of the exhaust capacity increasing, but the exhaust capacity is increased stepwise and sequentially every time an abnormality is detected, for example, 25,000 rpm, 27,500 rpm, 30,000 rpm. In this case, as notices to an operator, a warning may be issued when the revolution increases to 27,500 rpm and an alarm may be issued so as to corresponding to it quickly by differentiating the notice levels. Moreover, a construction for stopping the plasma processing to the next wafer by determining to be an abnormal state before changing the revolution can be adopted. For example, an abnormality warning is issued when the opening BR is more than 70° and a control for not moving the next wafer into the process chamber 101 is performed. In addition, a construction for controlling the each processing by the apparatus control unit 502 is adopted in the above description, but a construction for instructing the processing by the pressure controller 501 or the exhaust capacity controller 508 may also be adopted. In this case, the transmission/reception routes of data are properly changed.

As described above, a very small pressure fluctuation inside of the process chamber 101 can be detected on the basis of the opening BR of the pressure control valve 402 by performing the plasma processing in a state that the exhaust capacity is lowered and the variation of the opening of the pressure control valve 402 in response to the fluctuation of the chamber inner pressure P is large (a state that the change rate of the chamber inner pressure P in response to the variation of the opening of the pressure control valve 402 is reduced). Thus, the occurrence of abnormalities can be reliably detected and the occurrence of continuous and considerable processing deficiencies in a plasma-processed object thereafter can be prevented by detecting very small pressure fluctuation.

Although the abnormalities associated with the very small pressure fluctuation can be reliably detected by the above technique, reasons why the pressure fluctuation occurs, for example, abnormal discharge or flow rate fluctuation of introduced gas, etc. cannot be specified. Techniques for specifying reasons why the pressure fluctuation occur are described below.

First, a presence or absence of abnormalities of the pressure measuring unit 401 is determined. When abnormalities are absent in the pressure measuring unit 401, a presence or absence of the opening of the pressure control valve 402 is determined in a state that no gas is introduced into the process chamber 101. If abnormalities are absent in the confirmation, a presence or absence of the opening of the pressure control valve 402 is confirmed in a state that a gas is introduced into the process chamber 101. In case that plural gases are introduced into the process chamber 101 at the time of above pressure fluctuation detection, the presence or absence of abnormalities of the opening of the pressure control valve 402 is determined in a state that each gas is introduced into the process chamber 101 as single substance.

Reasons for the pressure fluctuation can be inferred by making the confirmation described above. Namely, when abnormalities are present in the pressure measuring unit 401, damage of the pressure measuring unit 401, zero point shift of the pressure measuring unit 401, etc. are inferred to be reasons for pressure fluctuation. When abnormalities in the opening of the pressure control valve 402 are present in a state that no gas is introduced into the process chamber 101, a leakage of the process chamber 101, an emission of degas inside of the process chamber 101 or an abnormality of the exhaust capacity, etc. are inferred to be reasons for pressure fluctuation. When abnormalities in the opening of the pressure control valve 402 are present in a state that a gas is introduced into the process chamber 101, damage or zero point shift, etc. of the flow controller of the gas are inferred to be reasons for pressure fluctuation. When abnormalities are absent in these confirmations, pressure fluctuation caused by leakage of He gas being a heating medium of rear side of the wafer 102 or abnormal discharge, etc. are inferred to be reasons for pressure fluctuation. In this case, a reproduction confirmation must be made by the plasma processing to another wafer.

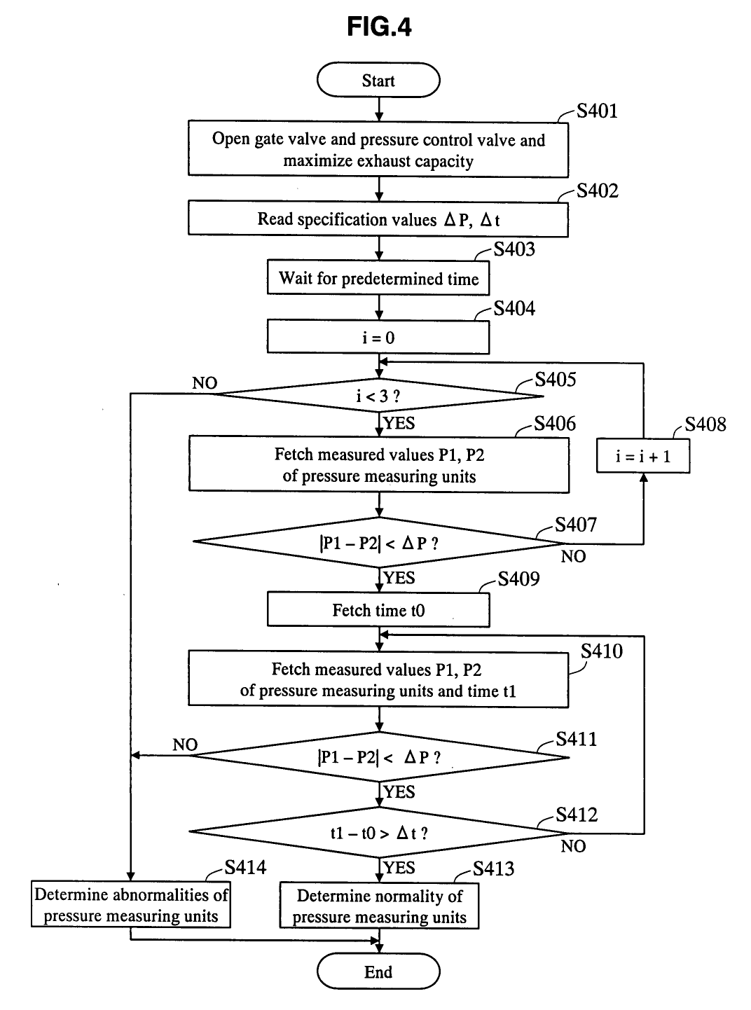

FIG. 4 is a flow chart showing a procedure for an abnormality confirmation processing of the above pressure measuring unit 401. As shown in FIG. 1, the pressure measuring unit 202 is connected to the wafer transport chamber 201 in the plasma processing apparatus of this embodiment. Here, the presence or absence of abnormalities of the pressure measuring unit 401 is determined using the pressure measuring unit 202.

If the confirmation processing is started, first, the gate valve 302 and the exhaust gas valve 106 are opened and the pressure control valve 402 are fully opened (the opening BR=90°) according to an instruction of the apparatus control unit 502. The apparatus control unit 502 maximizes the exhaust capacity of the turbo molecular pump 403 through the exhaust capacity controller 508 and starts an exhaust operation (step S401). At this time, the determination unit 505 reads a specification value ΔP and a time specification value Δt described later according to instruction by the apparatus control unit 502 (step S402). Here, the specification value ΔP is a specification value of a difference between a measured value of the pressure measuring unit 401 and a measured value of the pressure measuring unit 202. The specification value ΔP and the time specification value Δt are stored in the data storage unit 503 previously. Subsequently, it waits for a predetermined time until the pressures inside the chambers (the process chamber 101 and the wafer transport chamber 201) are stabilized (step S403). This predetermined time is set up in accordance with the volume of the process chamber 101 and the exhaust capacity. Here, the predetermined time is 60 sec.

After the predetermined time has elapsed, the apparatus control unit 502 fetches a measured value P1 of the pressure measuring unit 401 and a measured value P2 of the pressure measuring unit 202 with a counter i as 0 (step S404, step S405 YES, step S406). The fetched measured values P1, P2 are stored in the data storage unit 503, their difference is computed and the computation result is transmitted to the determination unit 505 by the data processing unit 504. The determination unit 505 compares an absolute value |P1−P2| of the difference between the measured value P1 of the pressure measuring unit 401 and the measured value P2 of the pressure measuring unit 202 and the specification value ΔP. If the absolute value |P1−P2| is greater than the specification value ΔP, the apparatus control unit 502 increments the counter i and fetches the measured value P1 of the pressure measuring unit 401 and the measured value P2 of the pressure measuring unit 202 once again (step S407 NO, step S408, step S405YES, step S406). In this embodiment, if the specification value ΔP cannot be satisfied in three measurements, the determination unit 505 determines that an abnormality is present in the pressure measuring units (step S405NO, step S414). In FIG. 4, the number of repeated measurements for each pressure measuring unit is three, but the number of repeated measurements may be one or more, and the number of repeated measurements can also be changed so that it is increased according to the state of the apparatus.

On the other hand, in the step S407, if the absolute value |P1−P2| of the difference between the measured value P1 of the pressure measuring unit 401 and the measured value P2 of the pressure measuring unit 202 is equal to the specification value ΔP or smaller, the determination unit 505 notifies that to the apparatus control unit 502. At this time, the apparatus control unit 502 fetches a time t0 at the moment from a non-illustrated time counter, then fetches the measured value P1 of the pressure measuring unit 401 and the measured value P2 of the pressure measuring unit 202 once again and a time t1 for fetching these measured values (step S407 YES, step S409, step S410). The fetched measured values P1, P2 and times to, t1 are stored in the data storage unit 503, each difference is computed, and the computation results is transmitted to the determination unit 505 by the data processing unit 504. The determination unit 505 compares the absolute value |P1−P2| of the difference between the measured value P1 of the pressure measuring unit 401 and the measured value P2 of the pressure measuring unit 202 and the specification value ΔP, if the absolute value |P1−P2| is greater than the specification value ΔP, the determination unit 505 determines that an abnormality is present in the pressure measuring units (step S411 NO, step S414). If the absolute value |P1−P2| of the difference between the measured value P1 of the pressure measuring unit 401 and the measured value P2 of the pressure measuring unit 202 is equal to the specification value ΔP or smaller, the determination unit 505 compares a difference t1−t0 of the time t1 and the time t0 and the time specification value Δt (step S411 YES, step S412). Then, if the difference t1−t0 is equal to the time specification value Δt or smaller, the apparatus control unit 502 fetches the measured value P1 of the pressure measuring unit 401 and the measured value P2 of the pressure measuring unit 202 once again (step S412 NO, step S410). On the other hand, if the difference t1−t0 of the time t1 and the time t0 is greater than the time specification value Δt, i.e., if the absolute value |P1−P2| is continued to be smaller than or equal to the specification value ΔP in the time interval Δt, the determination unit 505 determines that no abnormality is present in the pressure measuring units (step S412 YES, step S413). Thus, it can be confirmed that the pressure measuring units 401, 202 normally measure the pressure in high vacuum by confirming that the difference of measured values of each pressure measuring unit is continued to satisfy the specification value ΔP in a predetermined time interval Δt. For example, a time for plasma processing of one wafer can be set to the time specification value Δt.

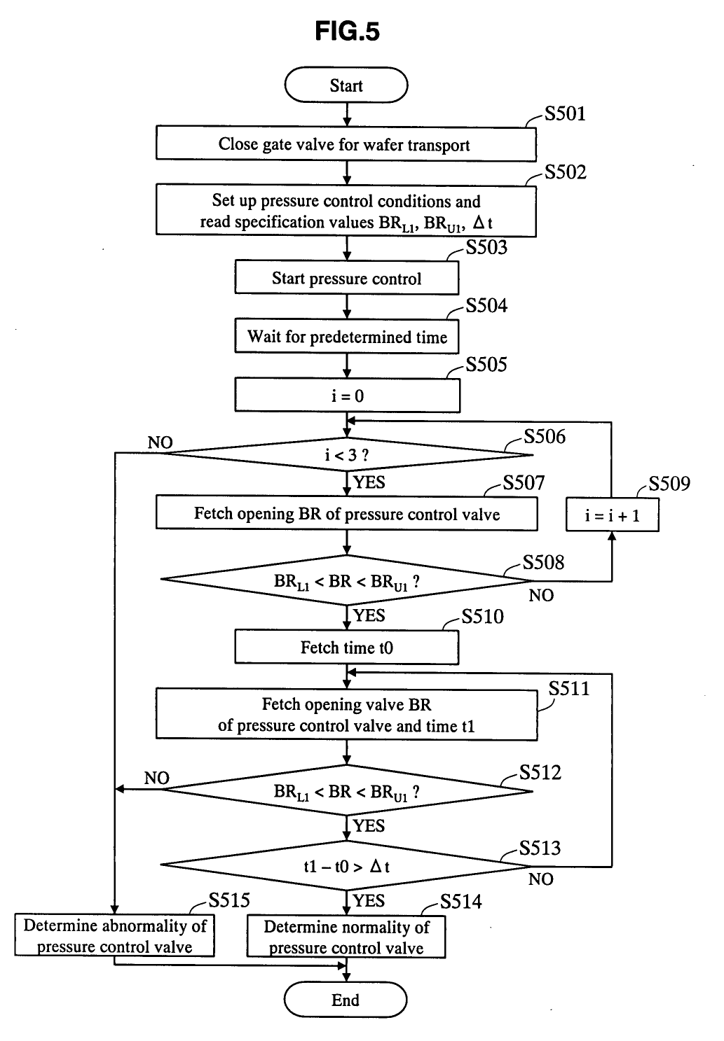

When no abnormality in the pressure measuring unit 401 is confirmed by the above confirmation processing, the opening of the pressure control valve 402 in a state that no gases are introduced into the process chamber 101 is confirmed. FIG. 5 is a flow chart showing a procedure of this confirmation processing. Here, when the pressure inside of the process chamber 101 is maintained to a pressure P_{A} in performing the plasma processing in which the above pressure fluctuation is detected, whether the opening BR of the pressure control valve 402 becomes a predetermined opening (50° in the above example) or not is determined.

If the confirmation processing is started, first, the gate valve 302 is closed according to an instruction of the apparatus control unit 502 (step S501). The apparatus control unit 502 sets up pressure control conditions in the exhaust capacity controller 508 and the pressure controller 501. Here, as the pressure control conditions, the apparatus control unit 502 sets up the pressure P_{A} inside of the process chamber 101 in performing the plasma processing in which the above pressure fluctuation occurs in the pressure controller 501. The apparatus control unit 502 also sets up an exhaust capacity, at which the opening BR of the pressure control valve 402 becomes the above predetermined opening (50° here) in a state that the pressure inside of the process chamber 101 without the introduced gas is made to the pressure P_{A}, in the exhaust capacity controller 508. Such an exhaust capacity can be fetched beforehand by performing an experiment in the plasma processing apparatus in a state that the plasma processing can be normally carried out.

At this time, the determination unit 505 reads a lower limit specification value BR_{L1} of the opening BR of the pressure control valve 402, an upper limit specification value BR_{U1} of the opening BR and a time specification value Δt prestored in the data storage unit 503 based on an instruction of the apparatus control unit 502 (step S502). Here, the lower limit specification value BR_{L1} of the opening BR is 45°, the upper limit specification value BR_{U1} of the opening BR is 55°, and the time specification value Δt is 30 sec.

Next, the apparatus control unit 502 starts the exhaust at the above exhaust capacity in the turbo molecular pump 403 through the exhaust capacity controller 508 and starts the pressure control in the pressure controller 501 (step S503). Subsequently, it waits for a predetermined time until the pressure inside of the process chamber 101 stabilizes at the pressure P_{A} (step S504). This predetermined time is similarly set up as the confirmation processing of the pressure measuring units in accordance with the volume of the process chamber 101 and exhaust capacity. Here, the predetermined time is 60 sec.

After the predetermined time has elapsed, the apparatus control unit 502 fetches the opening BR of the pressure control valve 402 with a counter i as 0 (step S505, step S506 YES, step S507). The fetched opening BR is stored in the data storage unit 503 and transmitted to the determination unit 505 by the data processing unit 504. The determination unit 505 compares the fetched opening BR and both the lower limit specification value BR_{L1}, and the upper limit specification value BR_{U1}. If the opening BR is not greater than the lower limit specification value BR_{L1} or not smaller than the upper limit specification value BR_{U1}, the apparatus control unit 502 increments the counter i and fetches the opening BR once again (step S508 NO, step S509, step S506 YES, step S507). In this embodiment, if the opening BR cannot satisfy the specification range (BR_{L1}<BR<BR_{U1}) in three measurements, the determination unit 505 determines that an abnormality is present in the pressure control valve 402 (step S506 NO, step S515). In FIG. 5, the number of repeated measurements of the opening BR is three, but the number of repeated measurements may be one or more, and the number of repeated measurements can also be changed so that it is increased according to the state of the apparatus.

On the other hand, in the step S508, if the opening BR of the pressure control valve 402 satisfies the specification range, the determination unit 505 notifies that to the apparatus control unit 502. At this time, the apparatus control unit 502 fetches a time t0 at the moment from a non-illustrated time counter, then fetches the opening BR of the pressure control valve 402 once again and a time t1 for fetching this opening (step S508 YES, step S510, step S511). The fetched opening BR and the times t0, t1 are stored in the data storage unit 503 by the data processing unit 504. Also, the difference between the time t1 and the time t0 is computed and the computation result is transmitted to the determination unit 505 by the data processing unit 504. The determination unit 505 compares the fetched opening BR and both the lower limit specification value BR_{L1} and upper limit specification value BR_{U1}. If the opening BR is not greater than the lower limit specification value BR_{L1} or not smaller than the upper limit specification value BR_{U1}, the determination unit 505 determines that an abnormality is present in the pressure control valve 402 (step S512 NO, step S515). If the opening BR is greater than the lower limit specification value BR_{L1} and smaller than the upper limit specification value BR_{U1}, the determination unit 505 compares a difference t1−t0 of the time t1 and the time t0 and the time specification value Δt (step S512 YES, step S513). Then, if the difference t1−t0 is equal to the time specification value Δt or smaller, the apparatus control unit 502 fetches the opening BR of the pressure control valve 402 once again (step S513 NO, step S511). On the other hand, if the difference t1−t0 of the time t1 and the time t0 is greater than the time specification value Δt, i.e., if the opening BR is continued to satisfy the specification range (BR_{L1}<BR<BR_{U1}) in the time interval Δt, the determination unit 505 determines that no abnormality is present in the pressure control valve 402 (step S513 YES, step S514). Thus, it can be confirmed that the pressure control valve 402 normally operates in high vacuum by confirming that the measured opening BR of the pressure control valve 402 is continued to satisfy the specification range in the predetermined time interval Δt. For example, a time for plasma processing of one wafer can be set as the time specification value Δt.

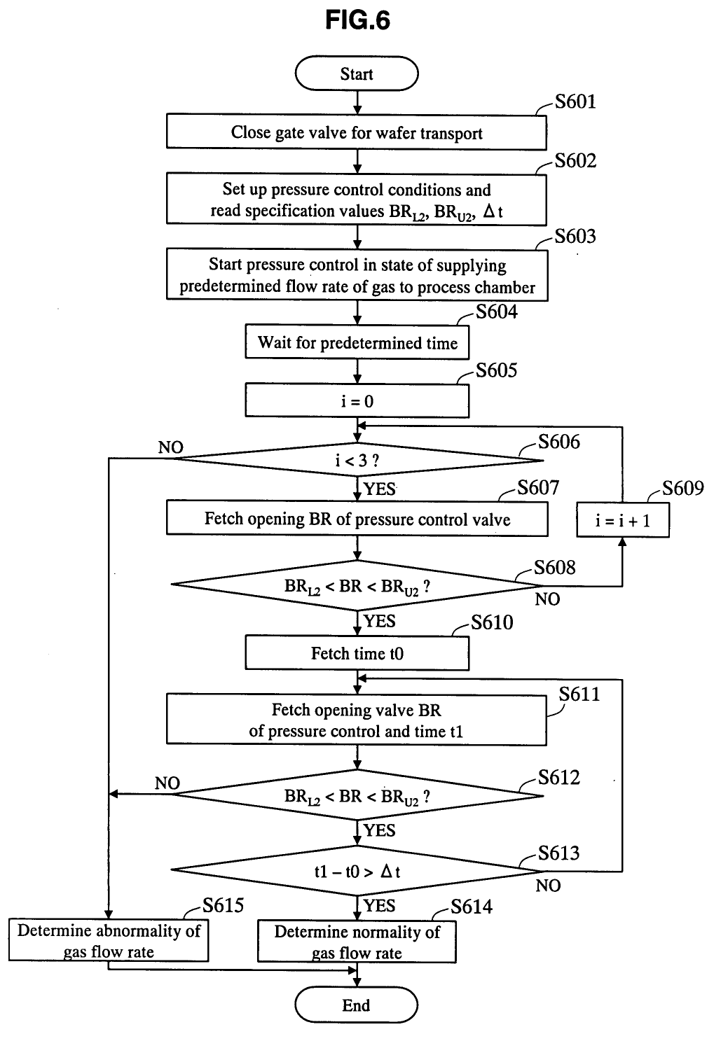

When no abnormality in the opening BR of the pressure control valve 402 is confirmed by the above confirmation processing in a state that no gas is introduced into the process chamber 101, the opening of the pressure control valve 402 in a state that a gas is introduced into the process chamber 101 is confirmed. FIG. 6 is a flow chart showing a procedure for this confirmation processing. Here, when the pressure inside of the process chamber 101 is maintained to the pressure P_{A} in performing the plasma processing in which the above pressure fluctuation is detected, whether the opening BR of the pressure control valve 402 becomes a predetermined opening (BR=50° in the above example) or not is determined.

If the confirmation processing is started, first, the gate valve 302 is closed according to an instruction of the apparatus control unit 502 (step S601). The apparatus control unit 502 sets up pressure control conditions in the exhaust capacity controller 508 and the pressure controller 501. Here, as the pressure control conditions, the apparatus control unit 502 sets up the pressure P_{A} inside of the process chamber 101 in performing the plasma processing in which the above pressure fluctuation occurs in the pressure controller 501. The apparatus control unit 502 also sets up an exhaust capacity, at which the opening BR of the pressure control valve 402 becomes the above predetermined opening in a state that the pressure inside of the process chamber 101 with the introduced gas made to the pressure P_{A}, in the exhaust capacity controller 508. The apparatus control unit 502 also sets up a gas flow rate in performing the plasma processing in which the above pressure fluctuation occurs in a non-illustrated gas flow rate controller of the gas supply system 109.

When plural gases are introduced into the process chamber 101 in performing the plasma processing, this confirmation is carried out for each gas. In this case, the apparatus control unit 502 sets up an exhaust capacity, at which the opening BR of the pressure control valve 402 becomes 50° in a state that the pressure inside of the process chamber 101 with single substance gas as confirmation target is made to the pressure P_{A}, in the exhaust capacity controller 508. Such an exhaust capacity can be obtained beforehand by performing an experiment in the plasma processing apparatus in a state that the plasma processing can be normally carried out. Moreover, when a single gas is introduced into the process chamber 101 in performing the plasma processing, the apparatus control unit 502 sets up the above low exhaust capacity (the revolution of the turbo molecular pump 403 is 25,000 rpm) as an exhaust capacity in the exhaust capacity controller 508.

At this time, the determination unit 505 reads a lower limit specification value BR_{L2} of the opening BR of the pressure control valve 402, an upper limit specification value BR_{U2} of the opening BR and a time specification value Δt prestored in the data storage unit 503 based on an instruction of apparatus control unit 502 (step S602). Here, the lower limit specification value BR_{L2} of the opening BR is 45°, the upper limit specification value BR_{U2} of the opening BR is 55°, and the time specification value Δt is 30 sec.

Next, the apparatus control unit 502 starts the exhaust at the above exhaust capacity in the turbo molecular pump 403 through the exhaust capacity controller 508 and starts the pressure control in the pressure controller 501 (step S603). Subsequently, it waits for a predetermined time until the pressure inside of the process chamber 101 stabilizes at the pressure P_{A} (step S604). This predetermined time is similarly set up as the confirmation processings described above in accordance with the volume of process chamber 101 and exhaust capacity. Here, the predetermined time is 60 sec.

After the predetermined time has elapsed, the apparatus control unit 502 fetches the opening BR of the pressure control valve 402 with a counter i as 0 (step S605, step S606 YES, step S607). The fetched opening BR is stored in the data storage unit 503 and transmitted to the determination unit 505 by the data processing unit 504. The determination unit 505 compares the fetched opening BR and both the lower limit specification value BR_{L2} and the upper limit specification value BR_{U2}. If the opening BR is not greater than the lower limit specification value BR_{L2} or not smaller than the upper limit specification value BR_{U2}, the apparatus control unit 502 increments the counter i and fetches the opening BR once again (step S608 NO, step S609, step S606 YES, step S607). In this embodiment, if the opening BR cannot satisfy the specification range (BR_{L2}<BR<BR_{U2}) in three measurements, the determination unit 505 determines that an abnormality is present in the gas flow rate (step S606 NO, step S615). In FIG. 6, the number of repeated measurements of the opening BR is three, but the number of repeated measurements may be one or more, and the number of repeated measurements can also be changed so that it is increased according to the state of the apparatus.

On the other hand, in the step S608, if the opening BR of the pressure control valve 402 satisfies the specification range, the determination unit 505 notifies that to the apparatus control unit 502. At this time, the apparatus control unit 502 fetches a time t0 at the moment from a non-illustrated time counter, then fetches the opening BR of the pressure control valve 402 once again and a time t1 for fetching this opening (step S608 YES, step S610, step S611). The fetched opening BR and the times t0, t1 are stored in the data storage unit 503 by the data processing unit 504. Also, the difference between the time t1 and the time t0 is computed and the computation result is transmitted to the determination unit 505 by the data processing unit 504. The determination unit 505 compares the fetched opening BR and both the lower limit specification value BR_{L2} and upper limit specification value BR_{U2}. If the opening BR is not greater than the lower limit specification value BR_{L2} or not smaller than the upper limit specification value BR_{U2}, the determination unit 505 determines that an abnormality is present in the gas flow rate (step S612 NO, step S615). If the opening BR is greater than the lower limit specification value BR_{L2} and smaller than the upper limit specification value BR_{U2}, the determination unit 505 compares a difference t1−t0 of the time t1 and the time t0 and the time specification value Δt (step S612 YES, step S613). Then, if the difference t1−t0 is equal to the time specification value Δt or smaller, the apparatus control unit 502 fetches the opening BR of the pressure control valve 402 once again (step S613 NO, step S611). On the other hand, if the difference t1−t0 of the time t1 and the time t0 is greater than the time specification value Δt, i.e., if the opening BR is continued to satisfy the specification range (BR_{L2}<BR<BR_{U2}) in the time interval Δt, the determination unit 505 determines that no abnormality is present in the gas flow rate (step S613 YES, step S614). Thus, it can be confirmed that the gas supply system 109 normally operates in high vacuum by confirming that the measured opening BR of the pressure control valve 402 is continued to satisfy the specification range in a predetermined time interval Δt. For example, a time for plasma processing of one wafer can be set as the time specification value Δt.

The confirmation processing of the opening of the pressure control valve in a state that no gas is introduced into the process chamber 101 and the confirmation processing of the opening of pressure control valve in a state that a gas is introduced into the process chamber 101 are made by a comparison with the plasma processing apparatus in the normal state. However, the exhaust capacity of the plasma processing apparatus is slowly changed with daily use due to the fact that reaction products generated in the plasma processing deposit inside exhaust pipe. Therefore, the more the accumulation of data fetched by the plasma processing apparatus in the normal state, the more accurately the above confirmations will be made. Namely, a tendency of daily exhaust capacity, etc. can be grasped and the above confirmations can be made more accurately by fetching data once per day or more in the plasma processing apparatus in the normal state and finely adjusting the specification values based on these data.

Although the opening of the pressure control valve 402 depends on process conditions, it tends to slowly increase in the plasma processing apparatus performing a plasma processing in which more reaction products generate. Thus, when the opening of the pressure control valve 402 slowly changes, a fluctuation of opening caused by such a time-elapsed change must be differentiated from a fluctuation caused by abnormalities. To make such differentiation, it is preferable that the variation of the opening of the pressure control valve 402 in the plasma processing is always monitored in combination with a comparison of the opening of the pressure control valve 402 in an immediately precedent plasma processing and the opening of the pressure control valve 402 in the current plasma processing. This enables detecting the variation of the opening of the pressure control valve 402 in a state that slowly changing opening of the pressure control valve 402 is considered and enables reliably detecting the fluctuation of the opening of the pressure control valve 402 generated due to abnormalities. When the processing interval between the current plasma processing and the immediately preceding plasma processing is not constant, the opening of the pressure control valve 402 sometimes fluctuates due to a difference of temperature distribution in the process chamber 101, in which case, the variation of the pressure control valve 402 is preferably monitored in a state that the amount of fluctuation of the pressure control valve 402 caused by the processing interval is considered.

As described above, very small pressure fluctuations in the process chamber 101 can be reliably detected according to the fluctuation of the opening of the pressure control valve 402. As a result, the abnormality occurrence can be detected at an early stage, reliably detecting the occurrence of abnormalities detected, preventing the occurrence of continuous and considerable processing deficiencies on objects processed thereafter.

Pressure fluctuation due to apparatus abnormality or process abnormalities can be easily differentiated. The plasma processing apparatus of this embodiment is constructed by adding an exhaust capacity controller and the computing unit to the prior apparatus and controlling them by the apparatus control unit. Accordingly, various measuring equipments corresponding to detection abnormalities need not to be added and the apparatus can be realized at a lower cost.

### Second Embodiment

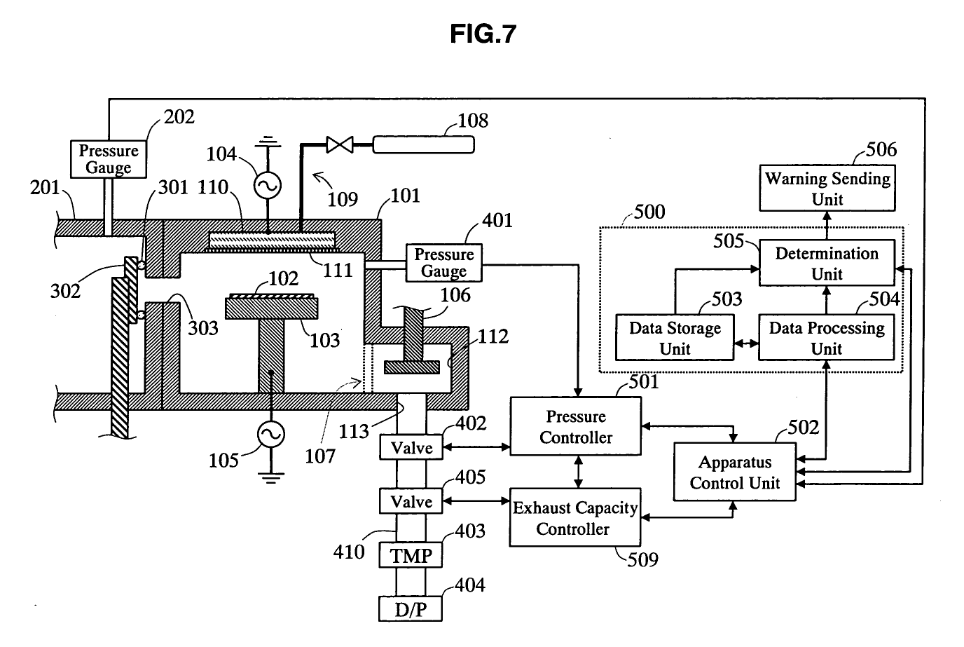

In the first embodiment, the exhaust capacity is reduced by changing the revolution of turbo molecular pump 403. However, the exhaust capacity can also be reduced by other techniques. FIG. 7 is a sectional view showing the construction of a plasma processing apparatus in the second embodiment relating to the present invention.

As shown in FIG. 7, the plasma processing apparatus of this embodiment is different from the plasma processing apparatus of the first embodiment in that it comprises an exhaust capacity control valve 405 between the pressure control valve 402 and the turbo molecular pump 403 as a means for reducing the exhaust capacity. Moreover, the plasma processing apparatus of this embodiment comprises an exhaust capacity controller 509 for controlling the opening of the exhaust capacity control valve 405 in place of the exhaust capacity controller 508 of the first embodiment. Other constructions are same as those of the plasma processing apparatus of the first embodiment. As the exhaust capacity control valve 405, a conductance variable valve, such as a butterfly valve, etc., can be used.

In this embodiment, the exhaust capacity controller 509 regulates the opening of the exhaust capacity control valve 405 based on an instruction of the apparatus control unit 502. Namely, the exhaust capacity controller 509 reduces the exhaust capacity by decreasing the opening of the exhaust capacity control valve 405. The exhaust capacity controller 509 increases the exhaust capacity by increasing the opening of the exhaust capacity control valve 405. Thus, the exhaust capacity can also be reduced and a state of greatly varying the opening of pressure control valve 402 by a very small pressure fluctuation inside of the process chamber 101 can also be realized by reducing the exhaust capacity in this embodiment.

In other words, in this embodiment, a very small pressure fluctuation inside of the process chamber can also be reliably detected on the basis of the variation of the opening of the pressure control valve 402 as the case in the first embodiment. As a result, the abnormality occurrence can be reliably detected, and the occurrence of continuous and considerable processing deficiencies on an object processed thereafter can be prevented.

### Third Embodiment

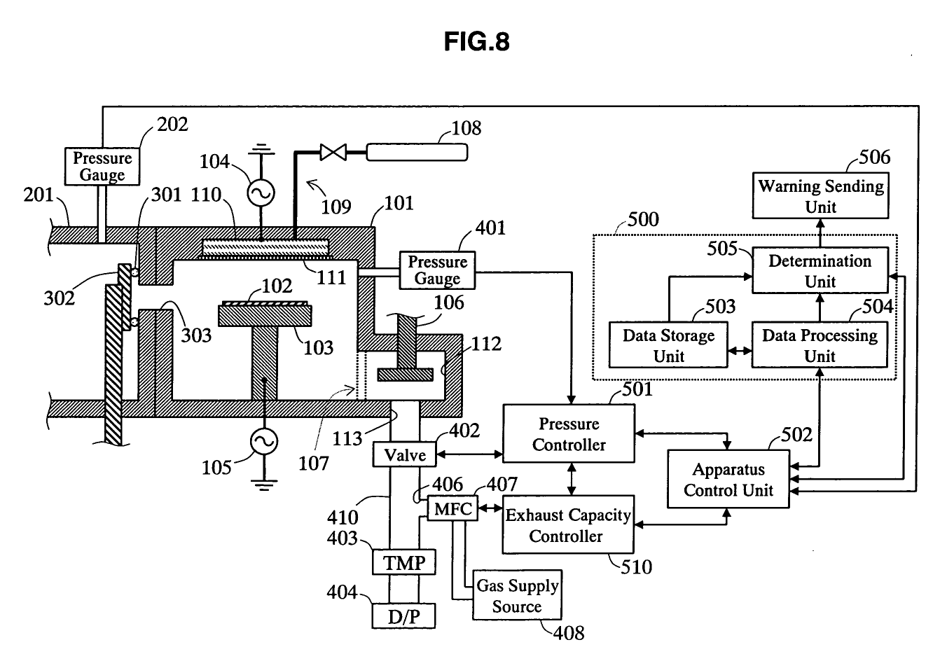

The exhaust capacity can also be reduced by a construction different from the first and the second embodiments. FIG. 8 is a sectional view showing the construction of a plasma processing apparatus in the third embodiment relating to the present invention.

As shown in FIG. 8, the plasma processing apparatus of this embodiment is different from the plasma processing apparatus of the first embodiment in that it comprises a gas supply port 406 between the pressure control valve 402 and the turbo molecular pump 403 as a means for reducing the exhaust capacity. A gas supply source 408 is connected to the gas supply port 406 via a gas flow controller (mass flow controller) 407. Moreover, the plasma processing apparatus of this embodiment comprises an exhaust capacity controller 510 for regulating the gas flow rate of the gas flow controller 407 in place of the exhaust capacity controller 508 of the first embodiment. Other constructions are same as the plasma processing apparatus of the first embodiment. An inert gas such as He gas or N₂ gas, etc. is preferably supplied from the gas supply source 408 so that unexpected reactions do not occur in the exhaust system though it is not specially restricted.

In this embodiment, the exhaust capacity controller 510 regulates the flow rate of gas passing through the gas flow controller 407 based on an instruction of the apparatus control unit 502. Namely, the exhaust capacity controller 510 reduces the exhaust capacity by increasing the flow rate of gas passing through the gas flow controller 407. The exhaust capacity controller 510 increases the exhaust capacity by reducing the flow rate of gas passing through the gas flow controller 407. Thus, the exhaust capacity can also be reduced and a state of greatly varying the opening of the pressure control valve 402 by a very small pressure fluctuation in the process chamber 101 can also be realized by reducing the exhaust capacity in this embodiment.

As in the first and the second embodiments, very small pressure fluctuation in the process chamber can also be reliably detected on the basis of the variation of the opening of the pressure control valve 402 in this embodiment. As a result, the abnormality occurrence can be reliably detected, and the occurrence of continuous and considerable processing deficiencies on an object processed thereafter can be prevented.

As described above, this invention enables reliably detecting a very small pressure fluctuation in the process chamber on the basis of the variation of the opening of the pressure control valve 402. Also, a pressure fluctuation due to apparatus abnormality or a pressure fluctuation due to process abnormality can be easily differentiated.

The present invention is not limited to the above embodiments described above, and various modifications and applications are possible within a scope where the effects of present invention are proved. For example, the constructions for varying the exhaust capacity described in the above embodiments need not be used, respectively and separately, any two or all of them can be adopted by combinations. For example, when there is a restriction on revolution in the turbo molecular pump 403, the control range of the exhaust capacity is limited, but the control range of the exhaust capacity can be made to a broader range by combining plural means for varying the exhaust capacity than the case of varying the exhaust capacity by only one means.

The present invention is not limited to the plasma etching apparatus, and it is also applicable to any plasma processing apparatus for performing a plasma processing to an object arranged in a process chamber.

The present invention is useful in methods for detecting abnormalities at an early stage during processing and before/after processing in a plasma processing apparatus such as dry etching apparatus, CVD apparatus, etc. used in the semiconductor manufacturing.

While the invention has been shown and described in detail, the foregoing description is in all aspects illustrative and not restrictive. It is therefore understood that numerous modifications and variations can be devised without departing from the scope of the invention.

1. A plasma processing apparatus for performing plasma processing to an object arranged in a process chamber, comprising:
a process chamber performing a plasma processing to an object;
a pressure measuring unit measuring a pressure inside of the process chamber;
a pump exhausting a gas in the process chamber;
a pressure control valve provided between the pump and the process chamber and maintaining the pressure inside of the process chamber to a predetermined pressure by regulating an opening based on a measured value of the pressure measuring unit;
a unit varying an exhaust capacity on the exhaust side than the pressure control valve; and
a unit detecting the opening of the pressure control valve.

2. A plasma processing apparatus according to claim 1, wherein the exhaust capacity is set up in a state that the opening of the pressure control valve at the time of maintaining the pressure inside of the process chamber to the predetermined pressure becomes a predetermined opening.

3. A plasma processing apparatus according to claim 2, wherein the predetermined opening is set up in accordance with a pressure fluctuation inside of the process chamber to be detected.

4. A plasma processing apparatus according to claim 1, wherein the unit varying the exhaust capacity is constructed by the pump with variable exhaust capacity.

5. A plasma processing apparatus according to claim 2, wherein the unit varying the exhaust capacity is constructed by the pump with variable exhaust capacity.

6. A plasma processing apparatus according to claim 3, wherein the unit varying the exhaust capacity is constructed by the pump with variable exhaust capacity.

7. A plasma processing apparatus according to claim 1, wherein the unit varying the exhaust capacity comprises an exhaust capacity control valve with variable opening provided between the pressure control valve and the pump.

8. A plasma processing apparatus according to claim 2, wherein the unit varying the exhaust capacity comprises an exhaust capacity control valve with variable opening provided between the pressure control valve and the pump.

9. A plasma processing apparatus according to claim 3, wherein the unit varying the exhaust capacity comprises an exhaust capacity control valve with variable opening provided between the pressure control valve and the pump.

10. A plasma processing apparatus according to claim 1, wherein the unit varying the exhaust capacity comprises a gas supply unit with variable flow rate for supplying a flow-controlled gas between the pressure control valve and the pump.

11. A plasma processing apparatus according to claim 2, wherein the unit varying the exhaust capacity comprises a gas supply unit with variable flow rate for supplying a flow-controlled gas between the pressure control valve and the pump.

12. A plasma processing apparatus according to claim 3, wherein the unit varying the exhaust capacity comprises a gas supply unit with variable flow rate for supplying a flow-controlled gas between the pressure control valve and the pump.

13. A plasma processing apparatus according to claim 10, wherein the gas supplied between the pressure control valve and the pump is an inert gas.

14. A plasma processing apparatus according to claim 11, wherein the gas supplied between the pressure control valve and the pump is an inert gas.

15. A plasma processing apparatus according to claim 12, wherein the gas supplied between the pressure control valve and the pump is an inert gas.

16. A plasma processing apparatus according to claim 1, wherein a pressure fluctuation inside of the process chamber is detected on the basis of a variation of the opening of the pressure control valve.

17. A plasma processing apparatus according to claim 2, wherein a pressure fluctuation inside of the process chamber is detected on the basis of a variation of the opening of the pressure control valve.

18. A plasma processing apparatus according to claim 3, wherein a pressure fluctuation inside of the process chamber is detected on the basis of a variation of the opening of the pressure control valve.

19. A plasma processing apparatus according to claim 1, wherein the exhaust capacity on the exhaust side than the pressure control valve is increased in case that the opening of the pressure control valve becomes a predetermined value or above.

20. A plasma processing apparatus according to claim 2, wherein the exhaust capacity on the exhaust side than the pressure control valve is increased in case that the opening of the pressure control valve becomes a predetermined value or above.

21. A plasma processing apparatus according to claim 3, wherein the exhaust capacity on the exhaust side than the pressure control valve is increased in case that the opening of the pressure control valve becomes a predetermined value or above.

22. A plasma processing apparatus according to claim 1, wherein the execution of plasma processing to an object to be processed subsequently is stopped in case the opening of the pressure control valve becomes a predetermined value or above.

23. A plasma processing apparatus according to claim 2, wherein the execution of plasma process on an object to be processed subsequently is stopped in case the opening of the pressure control valve becomes a predetermined value or above.

24. A plasma processing apparatus according to claim 3, wherein the execution of plasma process on an object to be processed subsequently is stopped in case the opening of the pressure control valve becomes a predetermined value or above.

25. A method for detecting abnormality of a plasma processing apparatus which comprises a pressure control valve between a process chamber arranged with an object and a pump for exhausting a gas in the process chamber and maintains the pressure inside of the process chamber to a predetermined pressure by regulating an opening of the pressure control valve, comprising the steps of:
setting the opening of the pressure control valve in a state of maintaining the pressure inside of the process chamber to a predetermined pressure to an opening corresponding to a pressure fluctuation inside of the process chamber to be detected by varying an exhaust capacity on the exhaust side than the pressure control valve;
maintaining the pressure inside of the process chamber to the predetermined pressure in a state of the set opening of the pressure control valve and performing a plasma processing; and
detecting a pressure fluctuation inside of the process chamber based on a variation of the opening of the pressure control valve.

26. A method for detecting abnormality of a plasma processing apparatus according to claim 25, further comprising the steps of
determining a presence or absence of abnormality of a pressure measuring unit measuring the pressure inside of the process chamber in case that the pressure fluctuation inside of the process chamber is detected;
determining a presence or absence of abnormality of the opening of the pressure control valve in a state that no gas is introduced into the process chamber and the pressure inside of the process chamber is maintained to the predetermined pressure in case of no abnormality in the pressure measuring unit; and
determining a presence or absence of abnormality of the opening of pressure control valve in a state that a gas is introduced into the process chamber and the pressure inside of the process chamber is maintained to the predetermined pressure in case of no abnormality in the opening of the pressure control valve without the introduced gas.

27. A plasma processing method applied to a plasma processing apparatus which comprises a pressure control valve between a process chamber arranged with an object and a pump for exhausting a gas in the process chamber and maintains a pressure inside of the process chamber to a predetermined pressure by regulating an opening of the pressure control valve, comprising the steps of:
setting the opening of the pressure control valve in a state of maintaining the pressure inside of the process chamber to a predetermined pressure to a predetermined opening by varying an exhaust capacity on the exhaust side than the pressure control valve; and
maintaining the pressure inside of the process chamber to the predetermined pressure in a state of the set opening of the pressure control valve and performing a plasma processing.

28. A plasma processing method according to claim 27, wherein the predetermined opening is set up in accordance with a pressure fluctuation inside of the process chamber to be detected.

29. A plasma processing method according to claim 27, wherein the exhaust capacity on the exhaust side than the pressure control valve is varied by regulating the exhaust capacity of the pump.

30. A plasma processing method according to claim 28, wherein the exhaust capacity on the exhaust side than the pressure control valve is varied by regulating the exhaust capacity of the pump.

31. A plasma processing method according to claim 27, wherein the exhaust capacity on the exhaust side than the pressure control valve is varied by regulating an opening of an exhaust capacity control valve provided between the pressure control valve and the pump.

32. A plasma processing method according to claim 28, wherein the exhaust capacity on the exhaust side than the pressure control valve is varied by regulating an opening of an exhaust capacity control valve provided between the pressure control valve and the pump.

33. A plasma processing method according to claim 27, wherein the exhaust capacity on the exhaust side than the pressure control valve is varied by regulating a flow rate of a gas supplied between the pressure control valve and the pump.

34. A plasma processing method according to claim 28, wherein the exhaust capacity on the exhaust side than the pressure control valve is varied by regulating a flow rate of a gas supplied between the pressure control valve and the pump.

35. A plasma processing method according to claim 33, wherein the gas supplied between the pressure control valve and the pump is an inert gas.

36. A plasma processing method according to claim 34, wherein the gas supplied between the pressure control valve and the pump is an inert gas.

37. A plasma processing method according to claim 27, wherein the exhaust capacity on the exhaust side than the pressure control valve is increased in case that the opening of the pressure control valve becomes a predetermined value or above.

38. A plasma processing method according to claim 28, wherein the exhaust capacity on the exhaust side than the pressure control valve is increased in case that the opening of the pressure control valve becomes a predetermined value or above.
